(19) United States
(12) Patent Application Publication
(10) Pub. No.: US 2013/0044030 A1
(43) Pub. Date: Feb. 21, 2013

(54) Dual Radiator Monopole Antenna

(71) Applicant: Sung Hoon Oh, Sunnyvale, CA (US)

(72) Inventor: Sung Hoon Oh, Sunnyvale, CA (US)

(21) Appl. No.: 13/212,316

(22) Filed: Aug. 18, 2011

(51) Int. Cl. H01Q 5/01

(52) U.S. Cl. 343/700 MS

(57) ABSTRACT

A dual radiator monopole antenna. An elongated low-band ground-coupled arm is disposed on a first surface of a printed circuit board. This arm is electrically connected to and spaced apart from a ground plane. An elongated high-band ground-coupled arm is disposed on a second surface of the printed circuit board, and like the low-band arm is electrically connected to and spaced apart from the ground plane. The high-band arm is oriented parallel to, and laterally displaced from, the low-hand ground-coupled ann. An elongated feed arm is disposed on the first surface of the printed circuit board, oriented parallel the ground-coupled arms and laterally displaced from them. A conductor in electrical feed connection with the feed arm extends from the feed arm across a portion of the ground plane.

### BACKGROUND

Current and next-generation wireless handsets need wide-band, multi-band antennas. This need is becoming particularly acute with the spreading adoption of fourth-generation long-term evolution (4G LTE) technology. Antenna bandwidth requirements have increased with this technology because the 700 megahertz (MHz) frequency bands are specified for 4G LTE. In addition, any such antenna must fit within the enclosure of a mobile telephone.

### BRIEF DESCRIPTION OF THE DRAWINGS

The drawings illustrate by example aspects and implementations of the invention.

FIG. 1 is a top view of a printed circuit board including an antenna according to principles of the invention.

FIG. 2 is a bottom view of the printed circuit board of FIG. 1.

FIG. 3 is a top view of elements of the antenna of FIG. 1.

FIG. 4 is a view of elements of an antenna according to principles of the invention.

FIG. 5 is a top view of a printed circuit board with foil etched to define elements of the antenna of FIG. 1.

FIG. 6 is a bottom view of a printed circuit board with foil etched to define an element of the antenna of FIG. 1.

FIG. 7 is graph of an actual measurement of the return loss of two prototypes of an antenna according to principles of the invention.

FIG. 8 is graph of an actual measurement of the efficiency of two prototypes of an antenna according to principles of the invention.

### DETAILED DESCRIPTION

In the drawings and in this description, examples and details are used to illustrate principles of the invention. However, other configurations may suggest themselves, and the invention may be practiced without limitation to the details and arrangements as described. Some known methods and structures have not been described in detail in order to avoid obscuring the invention. The invention is to be limited only by the claims, not by the drawings or this description.

Any dimensions are approximate. Terms of orientation such as “top” and “bottom” are used only for convenience to indicate spatial relationships of components with respect to each other; unless otherwise indicated, orientation is not critical to proper functioning of the invention. In the drawings and in this description, the same reference numerals will be used throughout to refer to the same or like parts.

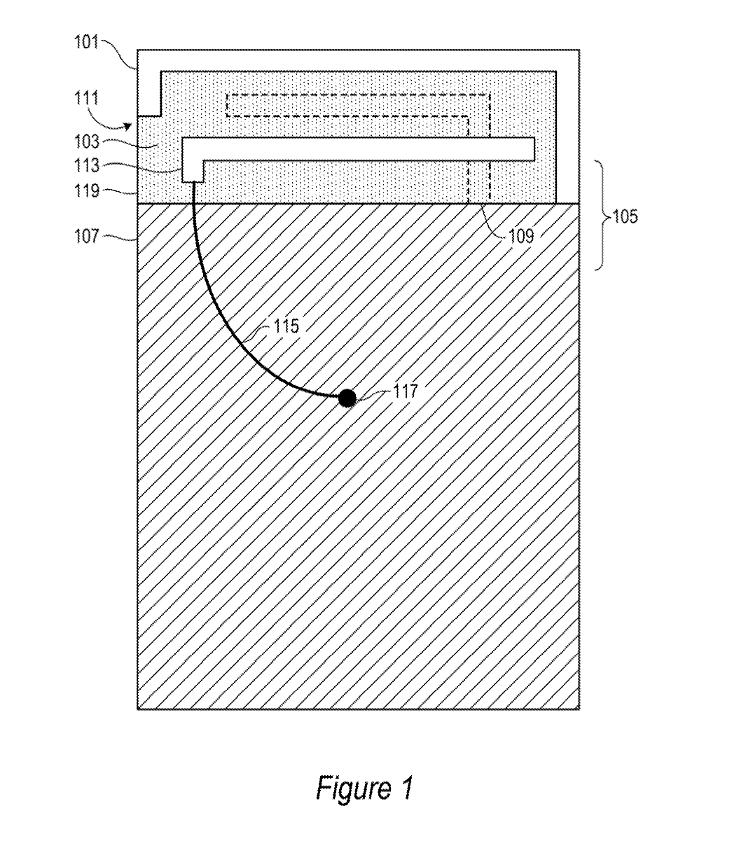

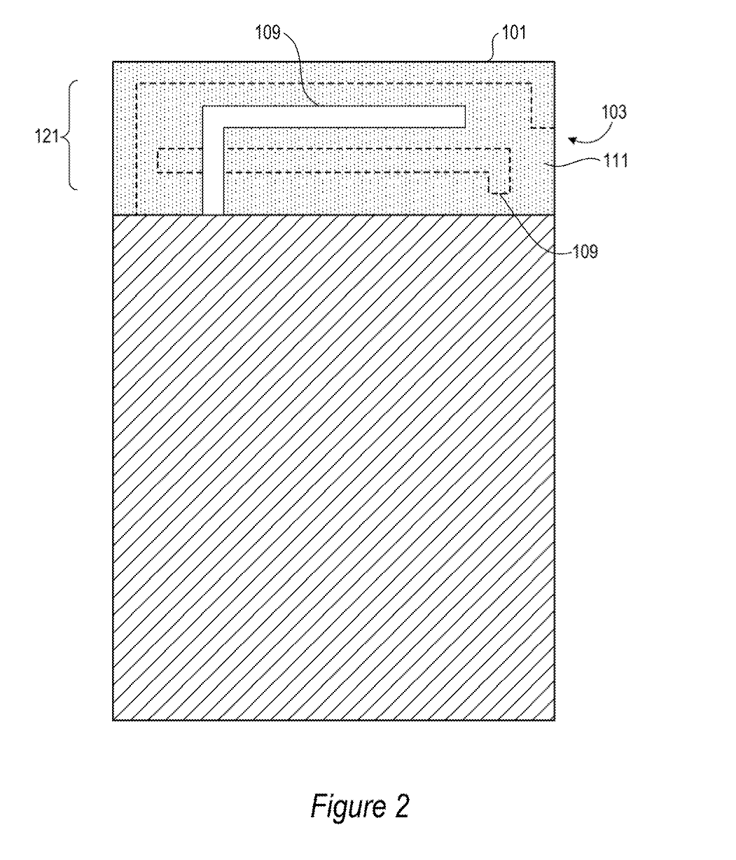

There is a need for an antenna that can fit within the confines of a portable appliance such as a mobile phone and that is operable both in existing frequency bands and in the new 4G LTE 700 MHz frequency bands. Referring to FIGS. 1 and 2, a dual radiator monopole antenna according to principles of the invention comprises an elongated low-band ground-coupled arm 101 disposed on a first surface 103 of a printed circuit board 105. The arm 101 is electrically connected to and spaced apart from a ground plane 107. An elongated high-band ground-coupled arm 109 is disposed on a second surface 111 of the printed circuit board, electrically connected to and spaced apart from the ground plane, oriented parallel the low-band ground-coupled arm 101, and laterally displaced therefrom. An elongated feed arm 113 is disposed on the first surface of the printed circuit board, oriented parallel the ground-coupled arms and laterally displaced therefrom. A conductor 115 is in electrical feed connection with the feed ann. The conductor extends from the feed arm across a portion of the ground plane 107.

The conductor may connect at a connection point 117 to an electronic component (not shown) carried by the printed circuit board, or the conductor may extend to a location remote from the circuit board. The conductor may comprise a radio-frequency waveguide.

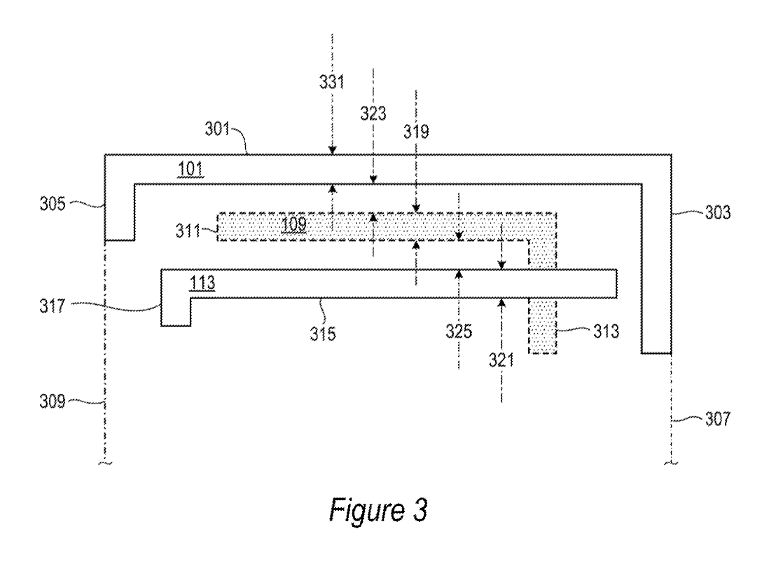

Referring to FIG. 3, the low-band ground-coupled arm 101 includes an elongated main body 301; an elongated first transverse element 303 at a first extremity of the main body, generally at right angles to the main body, terminating at the ground plane 107, and electrically connected thereto to establish the electrical connection between the ground plane and the ground-coupled arm; and an elongated second transverse element 305 at a second extremity of the main body and generally at right angles to the main body.

The main body 301 may extend substantially from a first edge 307 of the printed circuit board to an opposing second edge 309.

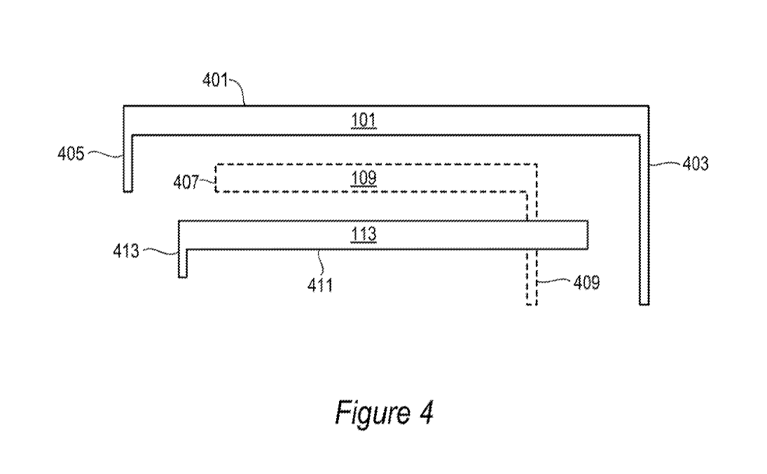

The main body may have a width 311, and the first and second transverse elements may each have substantially the same width as the main body. Or as shown in FIG. 4, the low-band ground-coupled arm 101 may have a main body 401 at least twice as wide as a first transverse element 403 or a second transverse element 405.

Dimensions may be determined by the available space in a mobile phone enclosure, or by desired frequency bands. In a prototype, the printed circuit board had overall dimensions of about 60 millimeters wide by 110 millimeters long. In this version the main body of the low-band ground-coupled arm was as long as the width of the circuit hoard, that is 60 millimeters, the first transverse element was about 11 millimeters in length and the second transverse element was about 6 millimeters in length.

The high-band ground-coupled arm 109 may comprise an elongated main body 311 and an elongated transverse element 313 at an extremity of the main body, generally at right angles to the main body, terminating at the ground plane. The transverse element 313 is electrically connected to the ground plane.

The feed arm 113 may comprise an elongated main body 315 and an elongated transverse element 317 at an extremity of the main body, generally at right angles to the main body. The transverse element 317 terminates at the conductor 115 and is electrically connected to the conductor, establishing the electrical connection between the conductor and the feed arm.

The feed arm 113 may cross over the high-band ground-coupled arm 109. These two arms are spaced apart from each other by the printed circuit board, the feed arm being disposed on the first surface 103 and the high-band ground-coupled arm 109 being disposed on the second surface 111 of the printed circuit board. The main body 315 of the feed arm crosses over the transverse element 313 of the high-band ground-coupled arm in the configuration shown in the drawings.

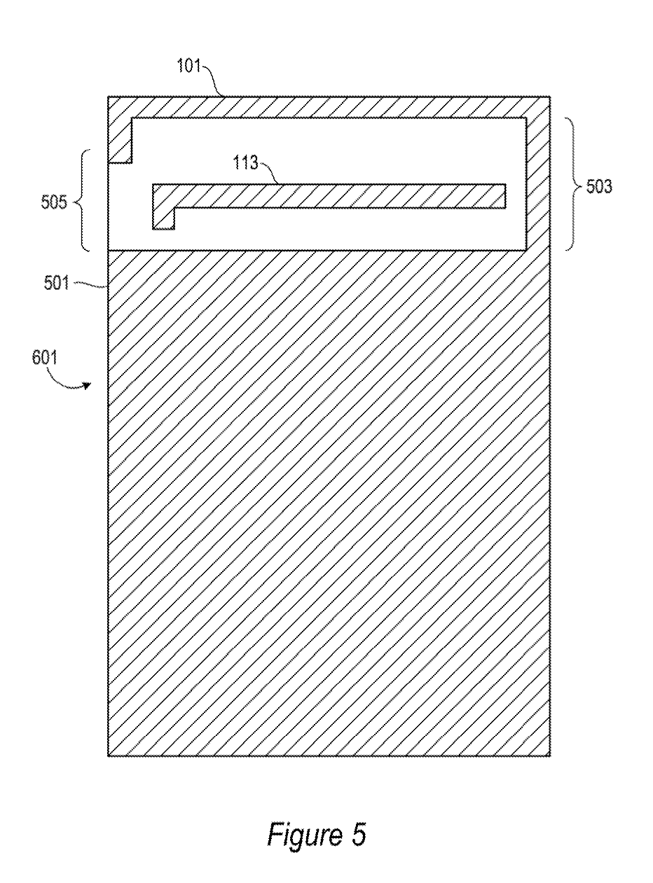

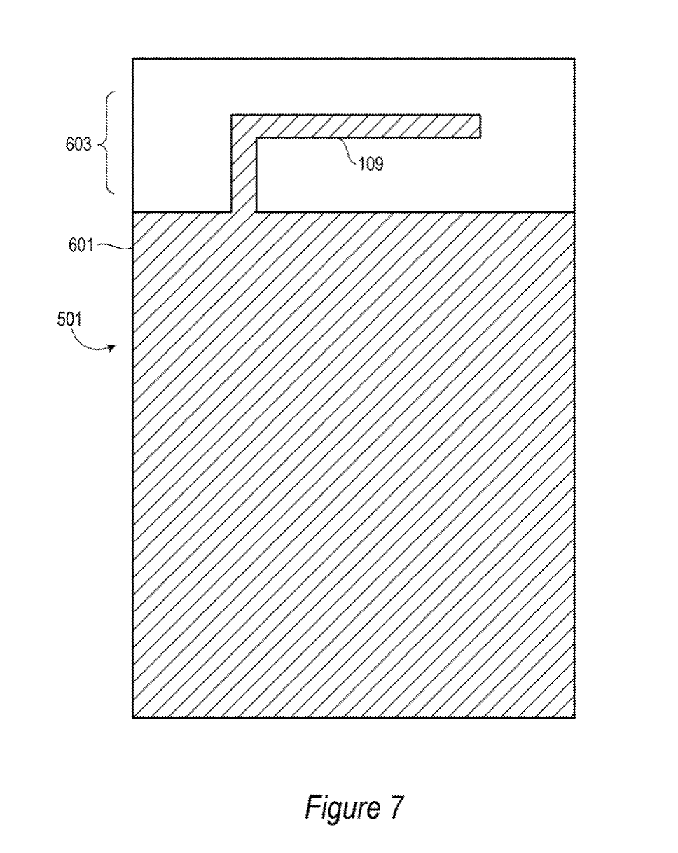

As shown in FIGS. 5 and 6, the ground plane may comprise a first sheet 501 of metal foil bonded to a first side of the printed circuit board, a second sheet 601 of metal foil bonded to a second side of the printed circuit board, and an electrically conductive path (not shown) between the first and second sheets. The low-band ground-coupled arm 101 may be formed in a portion 503 of the first sheet of metal foil, for example by etching the foil to define the arm 101.

Similarly, the feed arm 113 is formed in a portion 505 of the first sheet of metal foil that is electrically isolated from any other portion of the first sheet of metal foil, for example by etching the foil. Both arms 101 and 113 may be formed in a single etching operation as desired.

The high-band ground-coupled arm 109 may be formed in a portion 603 of the second sheet of metal foil, for example by etching the foil to define the arm 109.

Referring again to FIG. 1, an etching operation on the first surface 103 of the printed circuit board that forms the arms 101 and 113 will result in a portion 119 of the printed circuit board being bare of foil except for the arms 101 and 113. Similarly, etching the second surface 111 of the board to form the arm 109 will result in a portion 121 of the second surface being bare of foil except for the arm 109.

Turning again to FIG. 3, a width 319 of the high-band arm 109 may be substantially identical to the width 311 of the low-band arm 101. A width 321 of the feed arm 113 may also he substantially identical with the widths 311 and 319. But this is not critical, and these widths may differ from one another.

Similarly, a space 323 between the low-band arm 101 from the high-band arm 109 may be substantially identical in size to the width 311 of the low-band arm or it may differ. Also a space 325 that separates the high-band arm 109 from the feed arm 113 may be the same size as, or different than, the width 319 of the high-band arm or width 321 of the feed arm.

Turning again to FIG. 4, a main body 407 of the high-band arm 109 may be more than twice as wide as a transverse element 409. Similarly, a main body 411 of the feed arm 113 may be more than twice as wide as a transverse element 413.

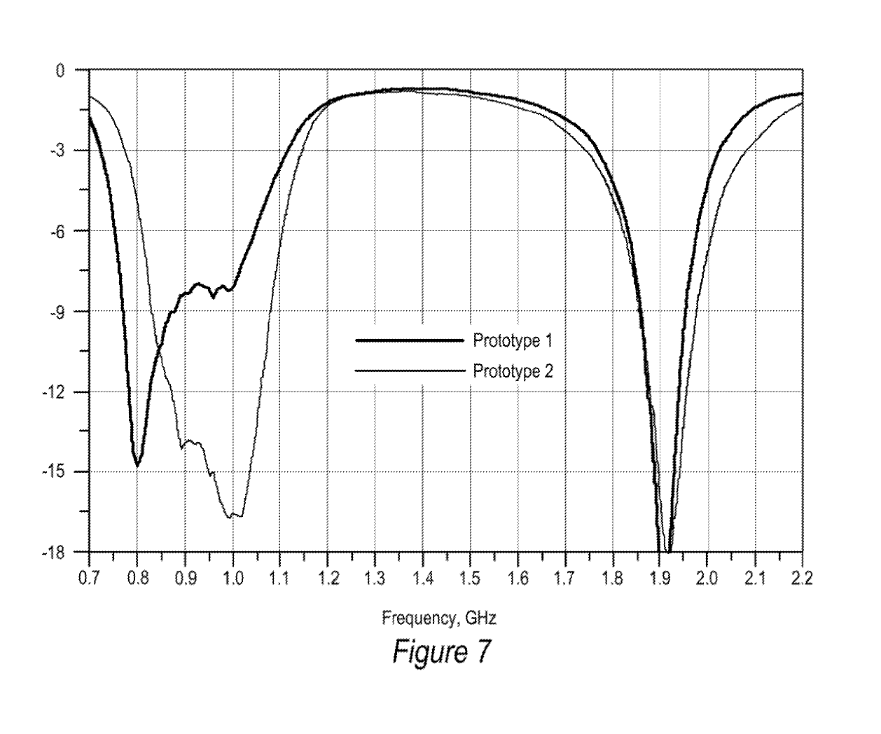

FIG. 7 shows a plot of measured antenna return loss vs. frequency for two prototype antennas constructed according to principles of the invention. The plotted frequency extends from 0.7 gigahertz (GHz) to 2.2 GHz. This plot shows a wide lowband bandwidth.

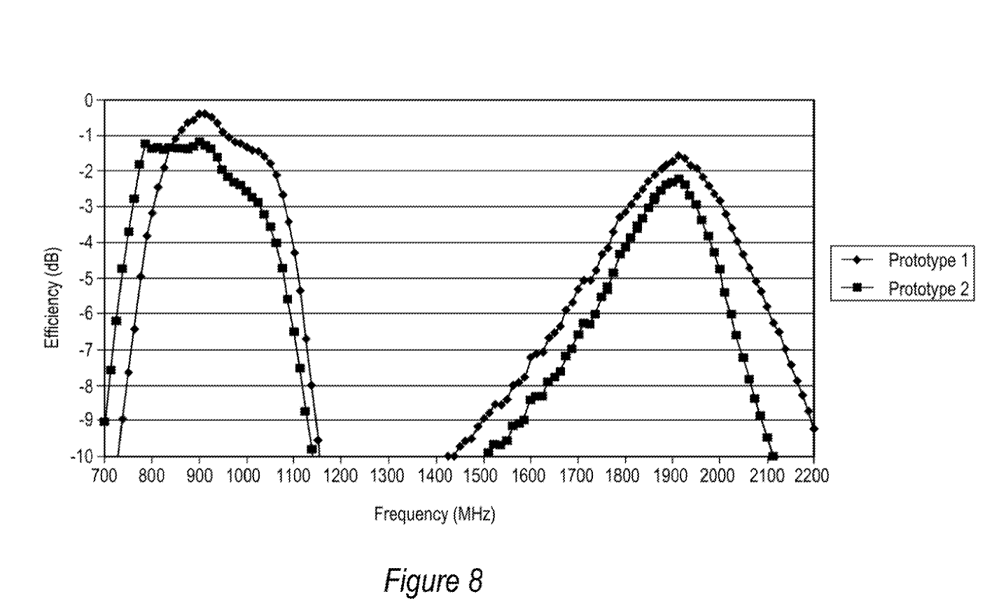

Finally, FIG. 8 shows the measured efficiency of the two prototypes plotted against frequency.

An antenna implementing principles of the invention as described above can be fabricated on a printed circuit board (FR4) and can accommodate the 700 MHz LTE bands while still covering the 0.85 GHz, 0.90 GHz, and 1.9 GHz frequency bands. The ground-coupled arms, used as part of the radiation elements, achieves multi-mode antenna resonances resulting in wide low-band bandwidth. These multi-mode resonances are achieved by capacitively coupling energy from the feed arm (driven antenna element) to the ground-coupled arms in order to re-radiate the coupled energy at the desired frequencies.

I claim:

1. A dual radiator monopole antenna comprising:
an elongated low-band ground-coupled arm disposed on a first surface of a printed circuit board, electrically connected to and spaced apart from a ground plane;
an elongated high-band ground-coupled arm disposed on a second surface of the printed circuit board, electrically connected to and spaced apart from the ground plane, oriented parallel the low-band ground-coupled arm, and laterally displaced therefrom; and
an elongated feed arm disposed on the first surface of the printed circuit board, oriented parallel the ground-coupled arms and laterally displaced therefrom; and
a conductor in electrical feed connection with the feed arm and extending from the feed arm across a portion of the ground plane.

2. The antenna of claim 1 wherein the low-band ground-coupled arm comprises:
an elongated main body;
an elongated first transverse element at a first extremity of the main body, generally at right angles to the main body, terminating at the ground plane, and electrically connected thereto to establish the electrical connection between the ground plane and the ground-coupled arm; and
an elongated second transverse element at a second extremity of the main body and generally at right angles to the main body.

3. The antenna of claim 2 wherein the main body extends substantially from a first edge of the printed circuit board to an opposing second edge thereof.

4. The antenna of claim 3 wherein the main body, the first transverse element, and the second transverse element each have substantially the same width.

5. The antenna of claim 3 wherein the width of the main body is at least twice the width of either of the transverse elements.

6. The antenna of claim 4 wherein the main body is about 60 millimeters in length, the first transverse element is about 11 millimeters in length and the second transverse element is about 6 millimeters in length.

7. The antenna of claim 1 wherein the high-band ground-coupled arm comprises an elongated main body and an elongated transverse element at an extremity of the main body, generally at right angles to the main body, terminating at the ground plane, and electrically connected thereto to establish the electrical connection between the ground plane and the ground-coupled arm;

8. The antenna of claim 1 wherein the feed arm comprises an elongated main body and an elongated transverse element at an extremity of the main body, generally at right angles to the main body, terminating at the conductor and electrically connected thereto to establish the electrical connection between the conductor and the feed arm.

9. The antenna of claim 8 wherein the feed arm crosses over the high-band ground-coupled arm.

10. The antenna of claim 9 wherein the main body of the feed arm crosses over a transverse element of the high-band ground-coupled arm.

11. The antenna of claim 1 wherein the conductor comprises a radio-frequency waveguide.

12. The antenna of claim 1 wherein the ground plane comprises a first sheet of metal foil bonded to a first side of the printed circuit board, a second sheet of metal foil bonded to a second side of the printed circuit board, and an electrically conductive path between the first and second sheets.

13. The antenna of claim 12 wherein the low-band ground-coupled arm is formed in a portion of the first sheet of metal foil.

14. The antenna of claim 13 wherein the feed arm is formed in a portion of the first sheet of metal foil that is electrically isolated from any other portion of the first sheet of metal foil.

15. The antenna of claim 12 wherein the high-band ground-coupled arm is formed in a portion of the second sheet of metal foil.
